(19) United States
(12) Patent Application Publication
(10) Pub. No.: US 2003/0055668 A1
(43) Pub. Date: Mar. 20, 2003

(54) Workflow engine for automating business processes in scalable multiprocessor computer platforms

(76) Inventors: Amitabh Saran, Bangalore (IN); Sanjay Suri, Bangalore (IN); Purushottaman Balakrishnan, Bangalore (IN); Shashidhar Kamath, Bangalore (IN)

Correspondence Address: STOEL RIVES LLP, 900 SW FIFTH AVENUE, SUITE 2600, PORTLAND, OR, 97204, US

(21) Appl. No.: 10/216,544

(22) Filed: Aug. 8, 2002

Related U.S. Application Data
(60) Provisional application No. 60/311,019, filed on Aug. 8, 2001.

(51) Int. Cl. G06F 17/60; G06F 15/16

(52) U.S. Cl. 705/1; 709/201; 709/206

(57) ABSTRACT

The present invention relates to a workflow and workflow engine. A workflow in accordance with the present invention is a process that gets triggered in response to a predetermined event in a relationship management system. The event could be anything input into the system, such as an incoming interaction like a phone call, a fax, an e-mail, or a web-form submission. In addition an event could be a business events such as an overdue task, an inventory update, a merchandise sale, or an equipment order. A workflow is preferably characterized in terms of a set of steps the workflow is to perform, such as creating or modifying a business object, creating and sending an email or fax, making a decision based on a query, scheduling a timed event, and so on.

### RELATED APPLICATIONS

This application is a continuation of and claims priority from U.S. Provisional Application No. 60/311,019 filed Aug. 8, 2001.

### COPYRIGHT NOTICE

©2002 Trivium Systems Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present invention relates to a workflow and a workflow engine for use preferably with a scalable multiprocessor relational platform architecture.

### BACKGROUND OF THE INVENTION

Most businesses use any and all strategies for managing customers and customer relationships. Historically managed by skilled sales people, today “customer relationship management” or CRM has moved from an art to a science, increasing the scale and reach of relationship management. There has been a marked increase in building operational processes for acquiring, serving and retaining customers and delivering services to them.

One aspect of this evolution is the need to interact with customers or business partners effectively over a variety of communication channels. While conventional mail and the telephone are still used, the many advantages and falling costs of other channels such as the Internet, VOIP, wireless PDAs, fax, WLAN etc. make them increasingly attractive to business users and their customers. At the same time, the availability of these and other channels presents a challenge to manage communications, regardless of the channel in use, in a unified way. To take a simple example, a user should be able to place an order via fax, and later check the status of that order via email, with no particular difficulty and ideally without human intervention on the vendor side.

On the other hand, communications channels are changing and evolving very rapidly, and which channels will dominate in the future is hard to predict. Yet businesses cannot afford to continually re-tool their computers and communication systems. What is needed is a platform that can be adapted, simply and therefore inexpensively, to accommodate changing communication channel requirements. Yesterday's automated fax server, for example, must become tomorrow's high-volume interactive Internet site—without substantial new investment.

For a CRM solution to succeed, the following requirements need to be fulfilled: the solution should offer a single cohesive view of the customer; the solution should manage not just the sales process but also leads, territories and pipeline management, forecasting, sales configuration and quote generation; the solution should also offer campaign management and prospective customer generation; the solution should further address customer service by recording interactions with customers, SLA, support both “one and done” and tiered support operations; the solution should be easy to use; a CRM solution should also allow for easy customization and integration of new channels.

Various software systems and architectures are known in the prior art, for a wide variety of business applications. One such system is described in U.S. Pat. No. 6,067,525 to Johnson et al. entitled, “Integrated Computerized Sales Force Automation System.” That system integrates salesperson support for multiple phases of the sales process (Abstract). The patent discloses a “layered architecture” illustrated at FIG. 20. The figure shows application, business objects, data and platform layers. The specification explains, “the layers communicate with each other through three defined protocols illustrated as protocol layers 2001, 2003 and 2005 . . . ” See column 31, lines 13 et seq. Because this vertical “layered” architecture requires a specific, dedicated protocol for communication at each level, changes at every level are constrained by the communication protocols. Integration with new components and external systems is cumbersome.

### SUMMARY OF THE INVENTION

The present invention relates to a workflow and workflow engine. A workflow in accordance with the present invention is a process that gets triggered in response to a predetermined event in a relationship management system. The event could be anything input into the system, such as an incoming interaction like a phone call, a fax, an e-mail, or a web-form submission. In addition an event could be a business events such as an overdue task, an inventory update, a merchandise sale, or an equipment order. A workflow is preferably characterized in terms of a set of steps the workflow is to perform, such as creating or modifying a business object, creating and sending an email or fax, making a decision based on a query, scheduling a timed event, and so on.

In accordance with the present invention, a workflow engine is responsible for scheduling and executing a workflow. Various communication channel adaptors exchange messages with the workflow engine and other processing modules via a scalable messaging platform that in a preferred embodiment is compliant with Java Messaging Service (JMS). The workflow engine allows for automation of responses to any events, such as for example those described above. Automation involves identifying and classifying an incoming interaction, routing the incoming interaction to an appropriate subsystem or business object, updating the overall system, and generating a reply to the incoming interaction.

A workflow operates on a set of rules, that in a preferred embodiment are exposed to end users and can be manipulated in a graphical user interface (GUI) environment. An example of a typical rule is as follows: for an incoming email/web form, determine the service group, within a predetermined set of service groups, to which an incoming interaction could be inserted. In addition, routing policies for the above rule can be based on several factors such as the following: email text's context (subject-based); local language; customer classes; performance; and representative availability. Other rules can be such that the workflow has a defined decision block that performs a predetermined action based on the results of a previous step or operation of the workflow. A users could also associate a timer with a step in the workflow to initiate tasks according to a predefined schedule. A workflow rule can also result in the workflow initiating an interaction with a database (typically through a data manager or DM) or a 3rd party application.

A workflow in accordance with the present invention can be represented as a Directed Acyclic Graph (DAG) with each node on the DAG representing a step in the execution of the workflow. Each step is atomic from a users' perspective and there is always a transition from one step to another that occurs in one direction. This helps to insure that a workflow can be recovered in a fairly simple manner.

A workflow in accordance with the present invention can be converted into a Finite State Machine (FSM). In an FSM representation of a workflow each step in the workflow is represented as a state in the FSM. However, this requires the maintenance of state information for all workflow threads. Maintaining threads in this manner can be unduly burdensome upon system resources under some circumstances particularly for a system dealing with a high volume of traffic. With this in mind, the present invention can include state information with each message that is initiated by a workflow, and thus obviate the need for maintaining each workflow thread. This allows the system to avoid the overhead that can be caused by maintaining a large number of threads at one time. Data and synchronization of state between objects is combined into each message sent by the workflow.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is a simplified block diagram illustrating a scalable architecture for business computing platforms in accordance with the present invention.

FIG. 2 is a first conceptual diagram illustrating operation of the messaging platform of FIG. 1.

FIG. 3 is a second conceptual diagram illustrating operation of the messaging platform of FIG. 1.

FIG. 4 is a third conceptual diagram illustrating operation of the messaging platform of FIG. 1.

FIG. 5A is a generic example of a message for transmission via the messaging platform of FIG. 1.

FIG. 5B shows the generic message of FIG. 5A in greater detail.

FIG. 5C shows a payload of the generic message of FIG. 5A in greater detail.

FIG. 6A is an example of a message from a hand-held inventory scanner (“HIS”) adapter to a workflow component to download physical inventory data.

FIG. 6B is an example of a message from a workflow component to a data manager to update inventory data.

FIG. 6C is an example of a message from a data manager to a workflow component responding to an inventory update message.

FIG. 7 is a simplified data flow diagram illustrating an events model for third-party integration to the platform of FIG. 1.

FIG. 8 illustrates another event-based method of third-party system integration.

FIG. 9 is a flow chart representation of a workflow for updating inventory records based on a physical determination of inventory in stock.

FIG. 10 is a flow chart representation of a workflow for updating inventory records based on a sale of an item at a retail location.

FIG. 11 is a flow chart representation of a workflow for re-ordering an item based on the quantity of the item remaining in a stores inventory.

FIG. 12 is a directed acyclic graph representation of a workflow.

FIG. 13 is a conceptual flowchart showing a workflow process within the workflow engine.

FIG. 14 shows a block diagram of the inner workings of the workflow engine that is typically triggered when workflow engine receives a WFStart event as shown in FIG. 13.

FIG. 15 shows a graphical user interface for designing a workflow.

FIG. 16 shows a graphical user interface for administrative use to set a particular workflow as a response to an incoming event or message.

### DETAILED DESCRIPTION OF PREFERRED EMBODIMENTS

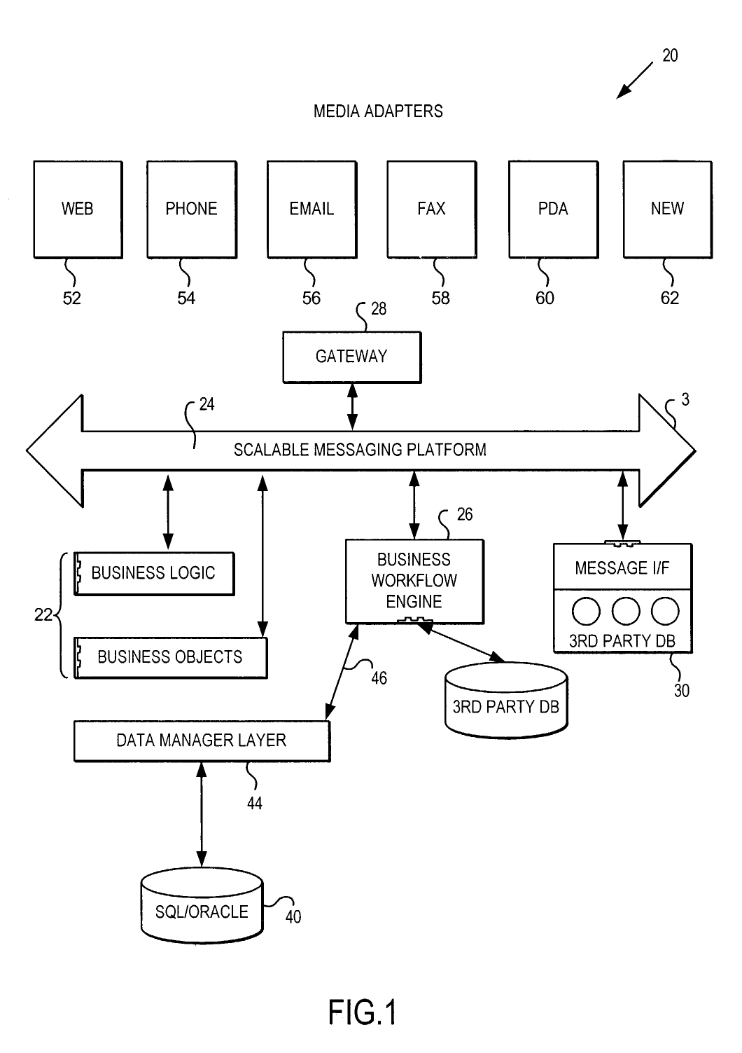

FIG. 1 is a simplified architecture diagram showing the principal components and interfaces of one example of a scalable platform according to the present invention.

In particular, FIG. 1 illustrates the conceptual layering and the communications employed. From a high level perspective, the major subsystems are Business Logic and Business Objects 22; Messaging Platform 24; Business Workflow Framework 26; Communications Gateway 28; and Application Integration Framework 30. These elements together form an extensible platform that is easily customized for many different industries and applications; it can be used in almost any commercial business enterprise, as further explained later.

Business Logic and Business Objects

The Business Logic and Business Objects 22 provide the means for managing and interacting with stored data. Preferably, a standard, commercially available database system, for example an SQL system from Oracle, 40 in FIG. 1, is implemented. The database 40 stores tables of data, as is conventional in a relational database, including data objects. These are accessed using standard queries by the Data Manager 44. The Data Manager decouples the rest of the system from the underlying database technology so that any appropriate database system can be used, and upgraded if necessary without changing the platform.

The Data Manager 44 translates business operations into the query language of the underlying database, so that business workflow operations (further discussed later) are database independent. The Data Manager also manages database connection pooling, so that a limited number of connections can be used while executing queries from multiple processes as needed. This helps to contain database licensing costs. In general, the Data Manager provides database access to the Business Workflow Engine 26 as indicated by interface arrow 46.

The Business Objects and Logic subsystem offers a consistent view of platform data and allows clients to perform high-level operations on these data. By “consistent view” we mean essentially that all of the various communication channels, workflow processes and applications utilize (and update) the same data, so it is necessarily consistent. For example, a given product description will be the same, whether accessed by a customer via fax or on the web.

High-level operations are enabled so that business logic and business objects “fit” the industry or application in which the platform is deployed. In a medical clinic application, for example, “customers” become “patients” and “products” may be medical procedures. Toward that end, “business objects” are software objects, including defined views, that are appropriate to the field of the application. The range of applications is virtually unlimited—examples include medical, education, real estate, automotive manufacturing, environmental cleanup, legal just to name a few. Thus a legal business object may be a will, or a litigation, or a court decision or a patent. An environmental business object may be a Superfund site, or a chemical, or an Environmental Impact Statement, etc.

Business Logic is again somewhat “vertical,” i.e., directed to specific industries or applications. Business logic imposes qualifications, constraints or operations on business objects, which can be thought of as rules, appropriate to the application.

The Business Objects and Logic subsystem also addresses system-wide common functions such as security, licensing, database access, and resource optimization. This functionality is exposed via the platform business API. In a presently preferred embodiment it comprises a Java® API and comes with XML “helpers” that provide efficient conversion between XML and Java objects. It also supports extensibility mechanisms for modifying or adding business rules, adding new business objects, and configuring for organization-specific databases and servers.

Security

In a presently preferred embodiment, the business platform implements a secure data access system that is useful with systems that have only one database, but can also be used with systems that have multiple databases. The security system uses rules to determine which resources of the database the user may access, which the user may view, and which resources the user may manipulate. In order to make this determination, the user is assigned at least one “role”, which determines, with few exceptions, the user's rights and privileges with regard to resource access and restrictions on resource viewing and manipulation once accessed. Thus, roles and rights and privileges determine to a large extent the user's capability to meet the security system's criteria for accessing resources in the database.

In order to administer database security, several strategies can be employed. These strategies include a hierarchical approach to organization of resources in a database; the use of “roles” that are applied to users (“accessors”) of the system, the use of automatic configurations to control access through roles; and the use of a query sub-system that permits the accessor to access only those resources that the user's role allows the user to “see” and to manipulate through rights and privileges that are granted to the accessor by the system. Each of these concepts are explained in more detail in our copending, concurrently filed application entitled, “Dynamic Rules-Based Secure Data Access System for Relationship Platforms,” U.S. Ser. No. ______.

In a business context, it may be desirable for certain people to have access to only information pertaining to certain business functions. For example, it may be desirable to restrict access of the sales force to sales information, and not to provide accounting information to sales representatives. On the other hand, it may be desirable to allow marketing personnel (or only certain ones of such personnel) access to sales, accounting, and customer relations information. Each business organization will have specific requirements, and the invention has the flexibility to accommodate these varying requirements. In accordance with the invention, each user that is allowed to access the system is assigned a “role” which is a designation of that person as an individual based on that individual's business function, and the user may be assigned other roles, based on groups to which that user belongs in the organization. Thus, each user may have multiple roles. For example, John Smith may be assigned a role of salesman, and may also be part of a “group role”, the sales reps group. Thus he has access based on two roles. He might further be assigned a role as a customer support person, and so have access to resources available to customer support personnel.

As an initial matter, business functions within the organization may be identified in setting up the secure access system. For example, sales, marketing and customer support. Once business functions have been identified, resources relating to these business functions resources may be organized, so that when a person who has been granted access rights (an “accessor”) to a particular business function, as explained below, accesses the resources of that business function via a terminal, the resources of that business functions are available to it on one or more screens. However, in most business organizations, it is not desirable for everyone to have access to all of the information relating to a particular business function. Hence, in accordance with the invention, each business function is further subdivided into “business objects”. These business objects are groupings of resources within the business functions, and relate to a collation of related business information. For example, while a business function is “Sales”, a business object may be “customers” in a certain geographic region, another business object may be a grouping of certain “products”; and another business object may be “sales opportunity”.

In addition, the resources may be further divided into “attributes”, and these attributes may be accessed by those that have been authorized by assigned role or otherwise. Thus, a business object may have a multiplicity of attributes, and rights to access these may be selectively allowed or denied to accessors based on their roles. Attributes can be base data types like integer or character string; or can be other business objects. It is often desirable to further restrict the access of users of a system, so that even at the business object level, users may not access all the resources within each business object. For this reason, the invention provides a further level of data access control. Each business object is further organized into “instances”. Thus, for example, while the Sales function (as explained) may be divided into several business objects, the customer business object may in turn be further divided so that each customer is an instance.

The above hierarchical system of setting up at least four layers (functions, business objects, attributes and instances) within each business function provides a basis for controlling access to resources of the business function (i) at the business function level, (ii) the business object level, and (iii) the instance level. Thus, for example, a sales manager may have access to the entire sales function, and would be able to see on his screen all resources relating to sales. A regional sales manager may have access to only sales within a geographic area that she controls, and her screen would only display the resources of that business object. In accordance with the invention, these screens may be configured so that information that the manager is not authorized to access, will not display as “blanks” or in any other way indicate that not all information is being displayed. In other words, as far as the regional manager with access to only her authorized business objects is concerned, she may be lead to believe from her screen that she is accessing all resources.

In the preferred embodiment, platform information is formally described in a published data model, and implemented in a commercial relational database. Access to the data is accomplished through well-defined transactions and queries implemented in a multi-tier architecture to ensure scalability and performance. Tables and their interdependencies are mapped onto Business Objects (BO) as noted above. A predefined though API extensible Business Logic is used to provide interactions across BOs. Further queries can also be written to support arbitrarily complex logic for a business.

The Data Manager (DM) component 44 can be used to invoke any object or query. DM basically contains classes that act as an interface to the applications and the database. The classes get the requests from other components or applications and service them efficiently, so that the latter need not have to deal with the database specific details. To provide efficiency and maximal reuse of resources, the DM pools database connections across users. Configuration parameters are provided for setting the maximum number of connections to be opened. Methods are provided to validate the connections and clean up any expired connections from the pool.

Applications require well-defined means of obtaining business data either solitarily (retail mode) or in bulk. The present platform provides the following techniques to make this possible. These are collectively called object-querying methods as each mechanism returns complete business data objects (on success) or none at all (if the query failed). (Integration of third-party applications, with respect to messaging and communications, is discussed later.)

Object naming: This is a retail-mode mechanism where an application can get a business data object from its persistent storage if it can provide a name for that object. The name is also known as the URL. Typically an application creates a business object, asks the API layer to store that object, and then gets the URL of that object. If it remembers the name, SRP can help the application reconstruct the object back from storage. Internally, the URL of an Object will carry sufficient information to identify the object, such as the type of Object, its relationship with the Database (persistent storage).

Simple Query Building: This is a bulk-mode mechanism that allows an application to simultaneously obtain more than one object. This is a primitive OQL-like query (except that there is no language). A simple object query in this manner can specify join relationships between multiple objects, Boolean logical conditions and even supports nesting queries within other queries. The result of executing the query is formulated as a collection of ordered collections. In addition to the objects themselves, it contains control (meta) information about the objects themselves.

Steps involved in using this mechanism are:

1. Create or acquire the objects implementing a simple query.

2. Supply the objects that are to be queried along with relationship among them

3. (Optional) If using a nested query, supply the Object attribute info.

4. Supply the Criteria if any, for attribute of Object participating in the query

5. Execute Query to get the Collection of objects

Pre-defined Query: This is a bulk-mode mechanism used when it is not possible to use the Simple Query builder. The Query is pre-built to retrieve a set of business Objects that have complex relationship amongst them or their selection criteria are quite complex. The result of executing this query is formulated as a collection of ordered collections. In addition to the L0 objects themselves, it contains control (meta) information about the objects themselves.

Generic Query Object: This is a bulk-mode mechanism used if none of the previous techniques are suitable. This mechanism requires explicit knowledge of SQL and of the database. The result of executing this query is formulated as a collection of ordered collections. Unlike other query operations it returns only the individual attribute values (as in SQL). They bear no direct relationship with objects.

Platform Administration

The business platform described, once deployed, interacts with numerous users, clients, customers, etc., with minimal maintenance. For example, as explained later, it automatically “scales” to accommodate increases in user traffic or “events”. Nonetheless, some administration is necessary, especially prior to deployment and for subsequent “fine-tuning” or the introduction of new functionality. An administrative “console” (now shown) preferably includes on-screen interfaces or “screens” to (1) define business logic; (2) define business objects; and (3) define business workflows (see Workflow Editor below). These three activities, all somewhat interrelated, together define the application logic that transforms the generic platform into a specialized application specific platform.

Business Workflow Engine Overview

The Business Workflow Framework offers a flexible, extensible, visual programming platform for automating routine customer interaction tasks and business processes within an organization. Easy-to-use editors enable the user to define workflows that get triggered in response to events in the systems. These events could be incoming interactions such as phone call, fax, emails, and web-form submissions or business events such as overdue tasks or imminent expiry of warranty periods or other organization-specific events. Wizards can be implemented to simplify tasks such as getting a web form to trigger a workflow. Workflows themselves are defined in terms of steps such as creating or modifying a business object, creating and sending an email or fax, making a decision based on a query, scheduling a timed event, and so on. It is also possible to create custom steps as well. A versatile business workflow engine is responsible for scheduling and executing the workflows. Its flexible design makes it possible to execute custom workflow steps in an isolated environment for better fail-safety.

Various communication channel adapters exchange messages with the workflow engine and other processing modules via a scalable messaging platform 24. Referring to FIG. 1, it illustrates a Web adapter 52, a phone adapter 54, an e-mail adapter 56, a fax adapter 58 and a PDA adapter 60. New adapter 62 illustrates deploying an available adapter for any new communication medium.

Messaging Platform

The Messaging Platform subsystem 24 is not literally a message highway or bus as illustrated conceptually. Rather, it comprises a collection of processes or agents forming part of the integrated data and event management scheme. In a presently preferred embodiment, the message platform is compliant with the Java Message Service (JMS) standard. Each user of the message platform (a client) interfaces with an appropriate adapter that, in turn, interfaces to a connector that actually connects to the platform, in that the connector can send and receive messages to and from platform processes called agents. The message platform implements two primary forms of communication: Request-reply transactions—for instance, a user application needs to request configuration data from a server DB application; and Publish-Subscribe Messages—in which messages of selected types can be published using the message platform client ID to carry messages to user applications subscribing to those types of messages. In addition, monitoring applications (tracing, statistics, utilization monitors, etc.) can also subscribe to this information without any impact on network or server performance—the message is still only sent out on the message bus once.

All communication among internal components takes place on the Message Bus. Applications can utilize multiple ports to communicate between various modules in a point-to-point, as well as in a publish-subscribe (Write One Read All) fashion. The message bus will take care of:

Connection management and scalability

Message assembly and hiding the internal structure of a message

Marshalling/unmarshalling data within messages

Reliability

Message routing and subscription management

Subscribing and un-subscribing to messages is very fast, such that it is possible for applications to make and break subscriptions on a per-contact basis (if necessary) without causing undo overhead on critical server or network resources. Additional optimizations can be implemented for communications that occur on the same node through the use of shared memory.

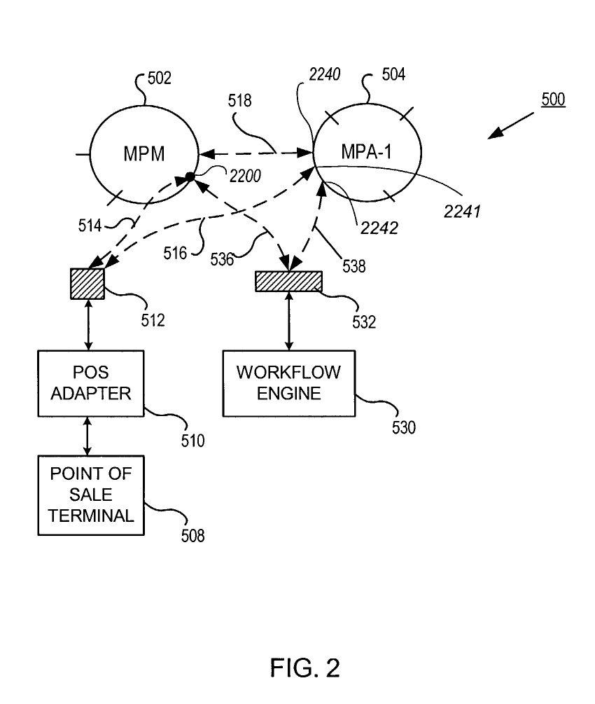

FIG. 2 is a first conceptual diagram illustrating operation of the messaging platform of FIG. 1. The messaging platform 500 includes at least one messaging platform manager (“MPM”) process 502 and at least one message platform agent (“MPA”) component 504. The message platform manager 502 starts up at initialization and creates the first MPA, in this case, MPA-1 504. The message platform manager oversees operation of the messaging platform, and implements additional connection ports as follows: First, the MPM 502 implements a well-known port number, here 2200, which will be used by any component seeking a connection to the message platform. When the MPM creates a message platform agent (MPA), it assigns a range of port numbers to that agent, and maintains a record of port assignments as further explained later.

In this example, we assume that the MPM implements port numbers 2200 to 2239 (although it only needs a few port numbers, as will become apparent) and it assigned port numbers 2240-2269 to MPA-1 when it was created. Next, we assume that an electronic point-of-sale terminal 508 is to be integrated with the present business computing platform. The point-of-sale (POS) terminal 508 is connected to a point-of-sale adapter 510. The point-of-sale adapter is arranged for communication with the POS terminal and is capable of buffering and reformatting data as appropriate to send and receive messages via the message platform 500. The POS adapter 510 is connected to a connector process 512, which is directly responsible for monitoring message traffic on the message platform and sending messages from the POS adapter.

Initially, the connector 512 sends a message 514 to the well-known port number 2200 requesting registration with the platform. The MPM 502 responds with a message assigning a port number for the connector 512 to use, in this case port number 2241. Logic in the connector 512 will then send a message 516 directed to port number 2241 which in FIG. 2 is implemented by MPA-1. (In the drawing, port numbers are shown in italics to distinguish from component reference numbers; also, port numbers are 2200 and higher in this illustration.) Communicating on the assigned port number 2241, the POS adapter then registers with the message platform as further explained below.

The message platform agent MPA-1 maintains a connection table internally that reflects each of the components registered with that agent. Here, that table will include an indication that the POS adapter is connected at port number 2241. As other components register, or unregister (become unavailable), MPA-1 updates its internal connection table, and it periodically transmits messages 518 to the message platform manager (MPM) process to update that information. In other words, a message platform update message includes in its payload the source MPA's connection table.

Next, a workflow engine 530 is initialized and seeks registration onto the message platform. The workflow engine 530 is coupled to a connector 532. As before, connector 532 sends a message to well-known port number 2200 requesting a connection to the message platform. MPM 502 examines its internal connection table and determines that the next available port number is 2242. It assigns that port number to the connector 532 via a message 536. In response, connector 532 sends a registration message 538 to MPA-1. As before, MPA-1 updates its connection table and furthers that information via message 518 to the platform manager 502. (Connection table management is further described below.) During subsequent operation, whenever the POS terminal 508 or the workflow engine 530 transmit a message onto the bus, the MPA-1 examines its connection tables to locate the indicated destination, and forwards the message to that port.

The message platform implements both request-reply transactions, as well as publish-subscribe transactions; the latter is implemented as follows. When a component/connector registers with the assigned MPA, it sends a message that includes an indication of those message types to which the component wishes to subscribe. In other words, it lists those classes of messages which should be forwarded to that component. Each component can subscribe to receive zero or more types of messages. (It may be a producer only.) By limiting its subscription to the types of messages required for its operations, message traffic is reduced and therefore efficiency and scalability are improved. Similarly, when a component/connector registers with the corresponding MPA, it can also include an indication of the message types that it will publish. Both publish and subscribe information is stored in the MPA local connection table, and is included in the connection data forwarded to neighboring message platform processes for routing purposes.

The message platform can be implemented using either a star or a serial chain configuration. The serial chain is presently preferred and is illustrated in the drawings. In that scenario, each MPA is connected to two adjacent neighbors, except for the MPM and the last MPA which form the endpoints of the chain.

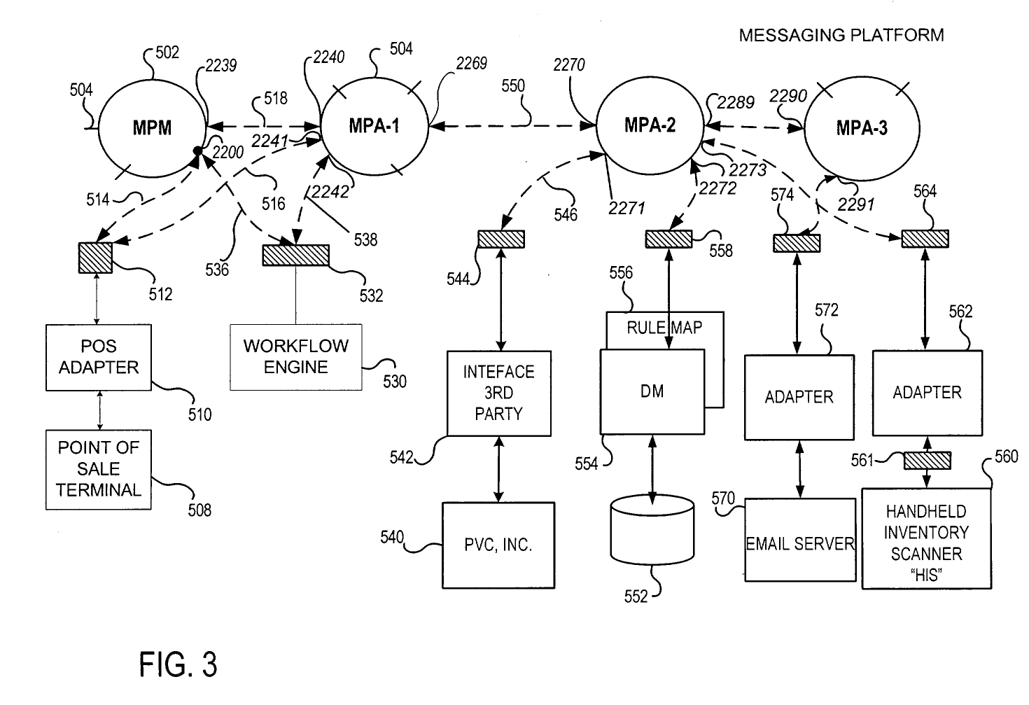

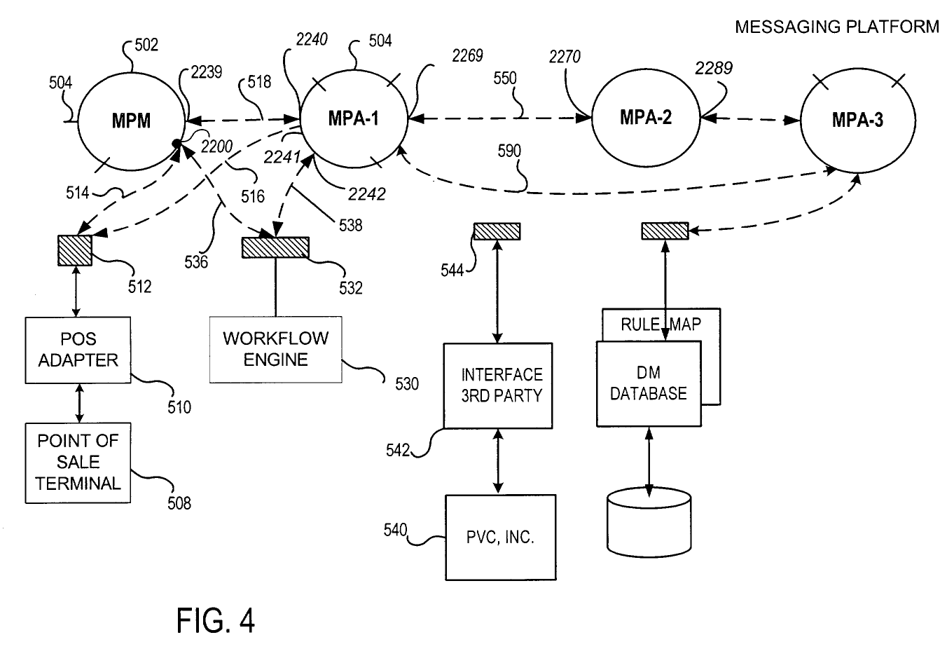

FIG. 3 is a second conceptual diagram illustrating operation of the message platform of FIG. 1. The left portion of FIG. 3 is substantially the same as FIG. 2. FIG. 3 illustrates further evolution of the message platform. As shown in FIG. 3, the MPM has spawned a second message platform agent MPA-2 to implement additional communication ports. We assume for illustration that the MPM assigns port numbers 2270-2289 to MPA-2. This information is retained as part of the connection table in the MPM.

Next, we assume that this business platform requires integration with a third-party vendor, in this case a company called PVC, Inc., a vendor of PVC pipes. The vendor's system 540 is coupled to a third-party interface 542 which includes logic for transferring messages, protocol conversion, and the like. Preferably, messages employ XML as a convenient mechanism for data exchange between disparate systems. The third-party interface 540 in turn is connected to a connector process 544 for interaction with the messaging platform. As before, the connector 544 initially contacts the MPM by sending a message to the well-known port number 2200. This is not illustrated but we assume that the MPM assigned port number 2271 to the third-party interface. Accordingly, the connector sends a message 546 to port 2271 on MPA-2 to register the PVC, Inc. connection. That registration can include an indication that PVC, Inc. subscribes to messages of the type vendor VEND_ and that it will publish messages of that type.

The illustrative system also implements an inventory database, preferably employing an industry standard database management system, such as an SQL system 552. The database system is connected to a data management (“DM”) component 554 of the type described above with reference to FIG. 1. The data manager maintains a rule map 556 indicating what business objects are stored in which database tables. The data manager communicates with a connector 558 process to access the messaging platform. We assume the initialization process described above, resulting in assignment of port number 2272 to the data manager. The data manager registers with MPA-2 to publish and subscribe to messages of the type inventory INV_.

A handheld inventory scanner device (“HIS”) 560 is used to take a physical inventory by an individual who moves about the warehouse scanning bar code numbers and entering quantity information. The HIS is then temporarily connected to the platform via a cable/connector 561 and adapter process 562. The HIS adapter includes logic for downloading inventory data from the HIS and formatting that information for transmission onto the messaging platform 500. The HIS adapter is connected to the platform via connector 564 to port number 2273, as shown. It is initialized and registers to publish and receive messages of the type inventory INV_.

The following table 1, “Messaging Platform Connection Table,” summarizes the messaging platform described thus far and provides an indication of the contents of each of the message platform processes.

TABLE 1
Messaging Platform Connection Table

| | CONNECTOR | PORT | PUBLISH | SUBSCRIBE |
|---|---|---|---|---|
| MPM | Well-known | 2200 | | MP_{—} |
| | MPA-1 | 2239 | MP_{—} | MP_{—} |
| MPA-1 | MPM | 2240 | MP_{—} | MP_{—} |
| | WF | 2242 | INV_, MAIL_, | INV_, MAIL_, |
| | | | VEND_{—} | VEND_{—} |
| | POS | 2241 | VEND_{—} | VEND |
| | MPA-2 | 2269 | MP_{—} | MP_{—} |
| MPA-2 | MPA-1 | 2270 | MP_{—} | MP_{—} |
| | TPI-1 | 2271 | VEND_{—} | VEND_{—} |
| | DM | 2272 | INV_{—} | INV_{—} |
| | HIS | 2273 | INV_{—} | INV_{—} |
| | MPA-3 | 2289 | MP_{—} | MP_{—} |
| MPA-3 | MPA-2 | 2290 | MP_{—} | MP_{—} |
| | E-MAIL | 2291 | MAIL_{—} | MAIL_{—} |

For each connection to a message platform process, there is an entry in the table comprising an identifier of the connected process, assigned port number, publication message types and subscription message types. The messaging platform manager MPM implements the well-known port number 2200 which is not configured to publish any messages, but subscribes to receive messages of the message platform type MP_. The MPM has allocated port numbers 2200-2239 to itself, although only the first and last ports are active. The last port number 2239 provides a connection to MPA-1, as indicated, and MPA-1 is registered to both publish and subscribe to message platform-type messages. The remainder of the table is self-explanatory and reflects the drawing FIG. 3.

The business platform illustrated in this example implements at least four classes of messages, namely message platform (MP_), inventory (INV_), e-mail (MAIL_), and vendor (VEND_). As the names imply, the MP class messages relate to maintenance and operation of the message platform itself. The inventory class of messages pertain to querying and updating the inventory database. The e-mail messages pertain to sending and receiving e-mail traffic. The vendor class of messages pertain to transactions with a connected third-party vendor, such as PVC, Inc., as illustrated in FIG. 3. Almost any combination of any number of components can be interconnected using a messaging platform of the type described. From a practical standpoint, a basic framework of preconfigured components is provided in a commercial embodiment of this platform, which can then be customized by the customer to conform to the its preferred business logic, practices and procedures.

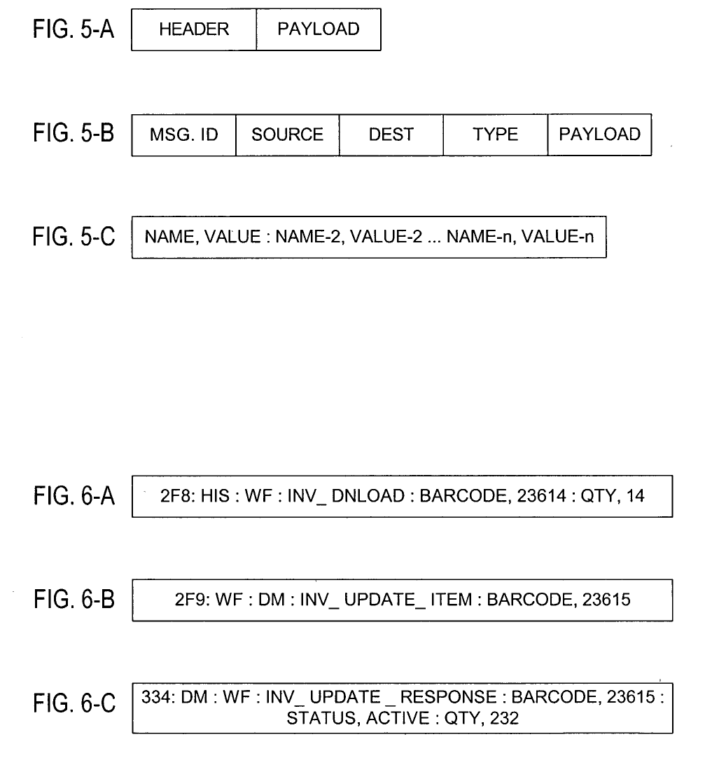

FIG. 5A shows an illustrative message format consisting of a header field and payload. The header field can include, for example, message ID (a serial number to identify the message and its sequence), source, destination and message type fields, as illustrated in FIG. 5B. FIG. 5C illustrates a payload format, comprising a series of field name and value pairs.

Examples of some specific messages are provided as follows. FIG. 6A illustrates a message sent from a hand-held inventory scanner (560 in FIG. 3) to a workflow engine. The message type INV_DNLOAD (inventory download) is an instance of the inventory class of messages. The payload in this example consists of two field name-value pairs, specifying a bar code number and a quantity. This is an example of a message that might be sent across the platform to update inventory records based on a physical inventory that was taken using the hand-held scanner. Referring to FIG. 3, the data originating with the hand-held scanner, and formatted by the HIS adapter 562, travels via the connector 564 to the assigned port 2273 on the platform agent MPA-2. Agent process MPA-2 consults its connection table and determines that the destination, workflow engine, is connected to a port (2242) on MPA-1. MPA-2 forwards the message accordingly. More specifically, MPA-2 determines that the workflow engine subscribed to receive messages of the inventory type (among others) as shown in the platform connection table above.

Referring now to FIG. 6B, this illustrates a message generated by the workflow to update the inventory database. It shows the workflow as the source, data manager as the destination, and the message INV_UPDATE_ITEM that is an instance of the message class INV_, and finally the payload comprises a single name-value pair, namely barcode number 23615. The workflow engine message traverses connector 532 to port 2242 on MPA-1 as shown in FIG. 3 and the connection table. MPA-1 consults its connection table and determines and identifies all of the components that have subscribed to receive messages of the inventory type. These include the data manager at port 2272 as well as the HIS at port 2273. (The HIS adapter 562 can buffer data when the HIS device is not attached.) The MPA forwards the message to the components that have subscribed.

The data manager will respond to the inventory update request by accessing the inventory database 552. The data manager maintains a rule map 556 for translating this type of business object update into a standard form query to the appropriate database table. FIG. 6C is an example of a message that might be sent from the data manager to the workflow engine providing a response to the inventory update request just described. The response in this case comprises three name-value pairs, namely the barcode number, the status of that barcode number, and the updated quantity of the corresponding item in inventory. The data manager includes secure infrastructure for accessing the database as described above.

In operation, the message platform connection data is dynamically updated and propagated as follows. The user can observe that each MPA process is connected to its left and right neighbors. These connections are assigned to corresponding communication ports, just as ports are assigned to connector processes. Thus, as indicated in the table (and FIG. 3), MPA-1 has its port number 2269 assigned for connection to MPA-2. Conversely, MPA-2 has its port number 2270 assigned for connection to MPA-1, and so on, so that these agents for a serial chain. The message platform agents communicate connection data to one another at regular intervals, or when changes occur, or “piggybacked” onto client messages. (Here we refer to a client of the messaging platform, i.e., a process coupled to the platform, for example through an adapter or third party interface.)

A message platform update message would be generally of the form MPA-X (source): MPA-Y (destination): Payload. Here, the payload is a connection list which may take the form, for example, of four field name-value pairs, where the fields are a connector I.D, port number, publish message types and subscription message types. (This information is acquired during the registration process described below.) The connection list data is provided for each active port of the subject agent. (The logic permits the publish and subscription fields to include multiple arguments.) Importantly, for each agent, two of its ports will be assigned to neighboring agents (except for the endpoints of the chain, as illustrated in Table 1 above). The payload entry corresponding to a neighboring agent will include in it the payload/connection data that the agent sending the present message received from that neighboring agent.

If one imagines these messages traveling from right to left in FIG. 3, from the last agent back to the managing process, one can see that the managing process in fact has a complete image of all active connections at any given time. This allows the MPM to spawn new message platform agents when required, to potentially reassign port numbers that have been closed, and to replace any MPA that no longer responds (died). Logic in the MPM can simply spawn a new agent, assign to it the port numbers previously assigned to the agent that died. This new information will automatically propagate through this system as described. In the chain configuration, each agent has knowledge of the connections to either side of it (immediately or through other agents) so that it can transmit messages to its ports accordingly.

Queuing Messages

The bus implements queuing within the client connector, both for read and write of messages. It provides reliability in delivering messages by implementing an implicit acknowledgement feature between the publisher and subscriber. Further there is a provision to automatically regulate the inflow of messages in the system (from media inboxes) so that a certain level of performance is maintained. Additional optimizations have been implemented in the communication component for server components that run together as a process, through the use of shared memory.

If a component on the messaging platform starts generating messages at a rate much greater than they can be consumed/transmitted by the platform, it could result in the component having to “slow down”. For example, in FIG. 3, both the Workflow Engine 530 and the POS terminal 508 are connected to the message platform MPA-1 504. On a good business hour, the POS terminal could be generating a lot of messages for MPA-1 to handle. If 530 starts getting active because of email and web requests needing to be routed in PVC Inc., MPA-1 504 may not be in a position to read messages from adapter 512 on port 2241. Consequently, the adapter 510 will not be able to post any new messages to 2241, and will stop accepting new messages from 508. In a cascading effect, the POS terminal 508 will not be able to send any messages to 510 and will either stop working or result in a “read error”.

In accordance with another aspect of the present invention, this traffic situation is taken into account by implementing a message queue in the connector and the adapter. The queue can be configured externally to a selected length (number of pending messages) appropriate for such traffic peaks in PVC Inc. The queue allows messages to be released to the next component at a rate that is acceptable to both components. It is like a reservoir of water before a high-rise dam.

In a further example of the system according to the invention, the POS terminal 508 may require all financial sales messages to reach the DM 554. In a conventional system this would require 508 to wait for an acknowledgement of every message it had sent to the DM 554. This would not only affect the performance of 508 and 554, it would also increase the traffic on the messaging platform (double, in this case) causing a negative impact on the performance of the whole system. To avoid this, our invention has introduced the concept of delivering messages reliably to a required destination. This is implemented by a retry mechanism in the queues in the connectors and adapters. This mechanism not only tries to send messages from the queue until they are successfully on the platform, but also implements an implicit acknowledgement scheme with the destination adapter/connector (in this case 558). This scheme allows multiple acknowledgements to be piggybacked on a single message thus reducing the platform load. If the originator 512 determines that a particular message has not be acknowledged (serial number of the message ID is missing in the piggybacked message acknowledgement), it resends it to 558.

Further, if the platform discovers that both adapters 512 and 558 are running on the same physical hardware machine, they will not exchange messages between MPA-1 and MPA-2. Rather, they will communicate using in-memory global data stores that both 512 and 558 can access simultaneously. This further reduces the load on the platform and improves the performance significantly.

Events Model for Third-party Integration

The business platform of the present invention preferably implements application integration, including a business logic API, to enable an external application or system (or many of them) to readily communicate with the platform. Interactions can be implemented in any one or preferably a combination of several ways, as follows.

First, external applications can synchronously interact with the platform business logic API by using any of the industry standard IPC middleware such as DCOM, CORBA, and RMI. Second, external applications can communicate asynchronously using a message oriented middleware (“MOM”). Here, a message dispatcher component routes the messages from the external applications to appropriate internal (platform) components and vice versa. And third, an external application or component can become a more directly integrated “member” of the platform by actually plugging into the messaging platform (through an adapter and connector) as described above. All messages can be based on the XML format. The platform provides the richness of business capabilities, to any interacting XML-based application.

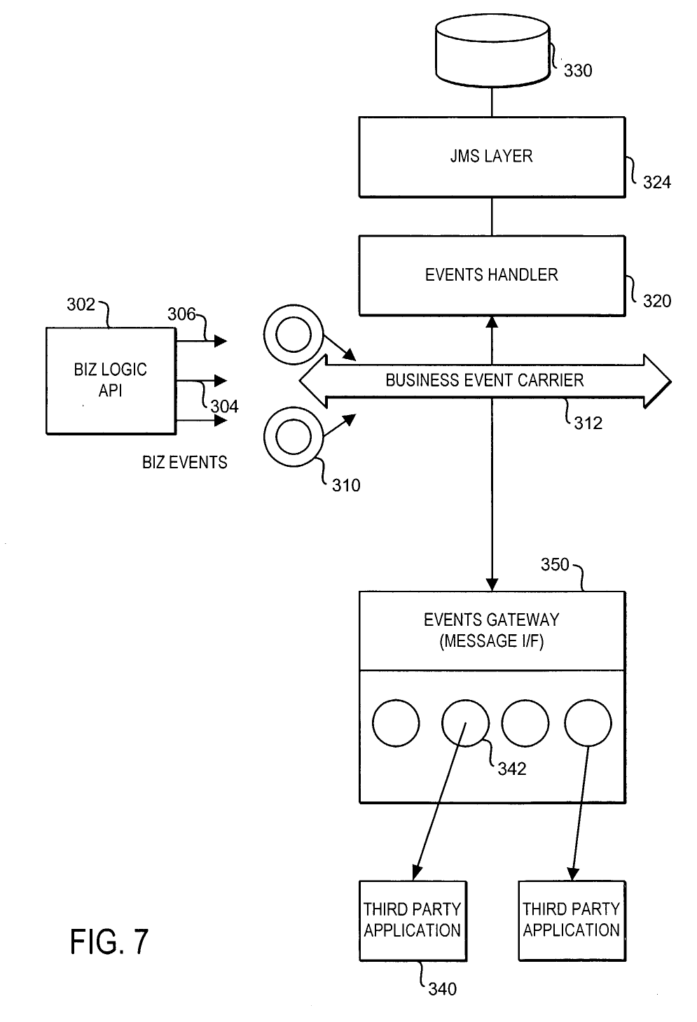

FIG. 7 is a simplified diagram illustrating an events model for third-party integration. Here, a business logic API 302 includes the ability to generate one or more business events 304,306. Generally, an event in the context of business logic is an indication of completion of a business process. Business events generally contain a payload which describes the data generated or affected by the business process. Third-party integration uses this payload. Preferably, the payload of the event can employ XML and comply with industry standards.

Referring again to FIG. 7, a business event is detected by an Event Service client 310. Such a client can be part of the connector (512, 532 and the like in FIG. 3) or the adapter (510, 572 and the like in FIG. 1) if one is connected directly to the messaging platform. The Event Service client 310 publishes the event via a business event carrier mechanism 312 (which could be, but is not limited to, the message platform (24 in FIG. 1) as described earlier) to an events handler 320. Alternatively (or additionally), the Event Service client 310 could publish a message responsive to the event to the messaging platform (24 in FIG. 1), although that method is typically handled by an adapter as described previously.

The message platform (24 in FIG. 1) can work in conjunction with a MOM implementation, and is responsible for maintaining persistent business events. The Events Handler 320 in this figure makes events persistent as needed. It interfaces to a JMS or other standard messaging compliant layer for storing the event in a database 330. Thus an Event Service client can access the database without going through a business workflow and data manager.

Third-party applications 340 can include components that subscribe to receive similar business events asynchronously. For example, a group of applications 340 is conceptually illustrated as having a component 342 that subscribes with an Events Gateway 350 to receive selected finance types of business events as they occur. Conversely, third party applications can be the source, i.e., they can publish selected events to the event service. To summarize, a business logic API fires a business event which in turn is received by an event service client. The ES client publishes the event. An Events Handler can capture the same, and initiate persistent storage if needed. An Events Gateway interfaces to third-party components to deliver events to which third-party applications have subscribed in near real time. All business events will be subscribed by this gateway and forwarded to interested third party applications, thus obviating the need for multiple copies of the same message moving in the messaging platform.

To further illustrate the events interface, we take as an example a vendor-customer relationship, in which the vendor maintains a business computing platform of the type described herein, and the customer maintains its own automated inventory system. The customer's inventory system is arranged to place an order with the vendor when a particular product is running low. This order can be entered through any of the channels (media adapters) described earlier, in which case it will trigger execution of a place order business workflow on the vendor's platform. Alternatively, the vendor's system, using a third party interface to the customer system as described further below, can “listen” for a business event to enter the order. Further, an order processing business logic component fires off an event to acknowledge receipt of the order. That event, in turn, may initiate an email (to the salesman, the customer or both). This can be done by the event handler or as part of a business workflow triggered by the order. The events handler also forwards the event as appropriate, including passing it, for example, to the MOM for persistent storage.

Preferably, all messaging utilizes HTTP or “web services” for convenient communication with desktop applications, via web browser, etc. By using XML for messages (events) internally, the platform can easily and automatically transform a message into a format or namespace specified by the third-party application. This approach closely integrates the platform and the third-party system in terms of functionality, yet does so without retooling or even touching the core “source code” of either system. Further, changes in the third-party system are quite easily accommodated by the vendor platform by changing or replacing the subscribing component.

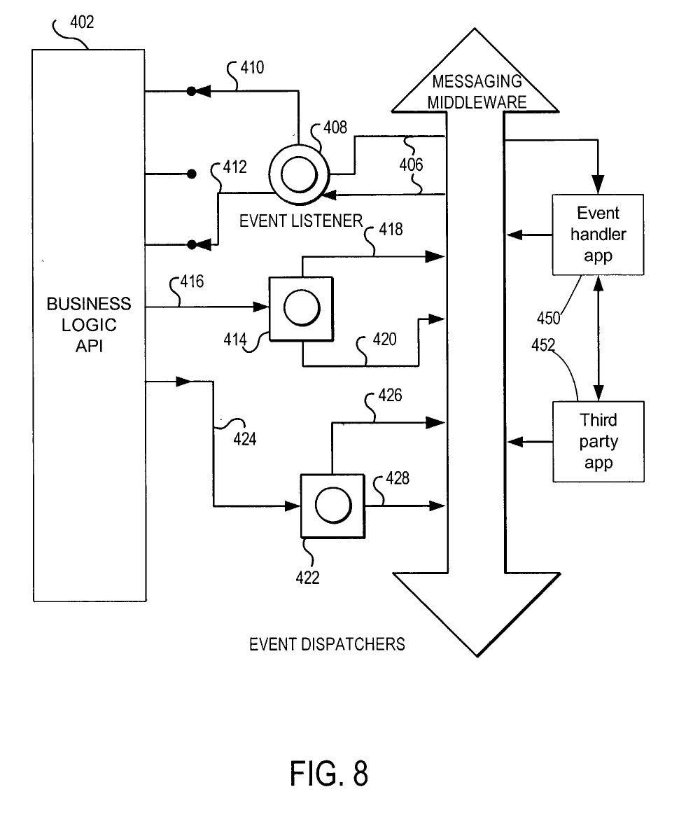

FIG. 8 also illustrates the use of events in the context of a third party interface. Here, a business logic API 402 can send and receive events, through the agency of event listeners 408 and event dispatchers 414, 422. The listeners, for example 408, detect selected events 406 from an MOM layer, which could be the messaging platform as defined in this invention.

An event dispatcher 414, 422 is an object whose sole purpose is to propagate the event—illustrated as 418, 420, 426, 428—to the Event Service. Event service could be an application like a Message Oriented Middleware (MOM, Eg:- MSMQ, Oracle AQ) or the messaging platform as described in this invention. In the presently preferred implementation shown in FIG. 8, the dispatcher sends the event to the MOM. It has the logic built in to talk to various MOM vendors. These may include use JMS—Java Messaging Service (324 in FIG. 7) or JNI-COM layers (not shown). A generic Event Handler application 450 is deployed to process events for third parties 452, either by receiving responses/events

The event listener is a process whose sole aim in the messaging platform is to listen to all the requests of third parties and process the requests using Business Logic API's. This also posts the responses to the requests back to the MOM. Event Listener could either pull the events/requests from MOM or MOM could push the events onto the listener. The MOM preferably provides Event persistence, support of multiple consumers for the same event, event expiration, retention and purging. Those skilled in the art will appreciate from this description that the events interface and related components can be configured to implement various push-pull scenarios for interaction with third parties synchronously or asynchronously.

Regardless of the particular attribute that an application must monitor, an application developer making a system in accordance with the present invention must typically build objects that share their state information with other interested objects. In order to fulfill this requirement, objects that work with the present invention are preferably designed with the capability to share their state information through a message bus to other processes. By extending these publish-subscribe objects, sophisticated applications can be built that automatically distribute their internal state to subscribing applications/objects. This simplifies the development process for application developers by letting them concentrate on the logic that their components must possess, and less on the mechanics of how to communicate this information outside of their own application.

In addition to publish-subscribe objects, additional state information is represented as data in a database connected to the relational platform. Because all data access is accomplished through well-defined queries to the database, it is possible to build data publishing events into the logic components. All events generated by applications are documented in the database.

When it receives a message of an appropriate type (i.e. a message type that workflow engine 530 subscribes to) workflow engine 530 will identify the message type based on the header of the message. Depending on the message type and other relevant characteristics the message workflow engine 530 will determine which particular workflow, and corresponding Finite state machine (FSM), should be created to handle the message. Workflow engine 530 will then generate a message to DM 554 requesting information necessary to create an instance of the appropriate FSM. DM 554 responds by generating a message to workflow engine 530 including a URL or other identifying information necessary for workflow engine 530 to create an instance of the appropriate FSM. Workflow engine 530 will then create and execute an instance of the appropriate FSM. As discussed above, the FSM representation of a workflow includes a set of states (all possible states) for the workflow, with each state corresponding to a particular action which must be taken by workflow engine 530.

For example, workflow engine 530 would identify the message shown in FIG. 6A, as being of the type INV_DNLOAD. In response, to a message of that type, workflow engine 530 would request DM component 554 to provide it with an instance of an Physical Inventory Update FSM corresponding to the workflow shown in Fig. DM 554 sends a response back to workflow engine 530 with information necessary for workflow engine 530 to create an instance of the appropriate FSM. Workflow engine 530 will preferably store the information from the response in a memory cache (not shown). Workflow engine 530 will begin to execute the steps of the appropriate FSM on the INV_DNLOAD message as described below.

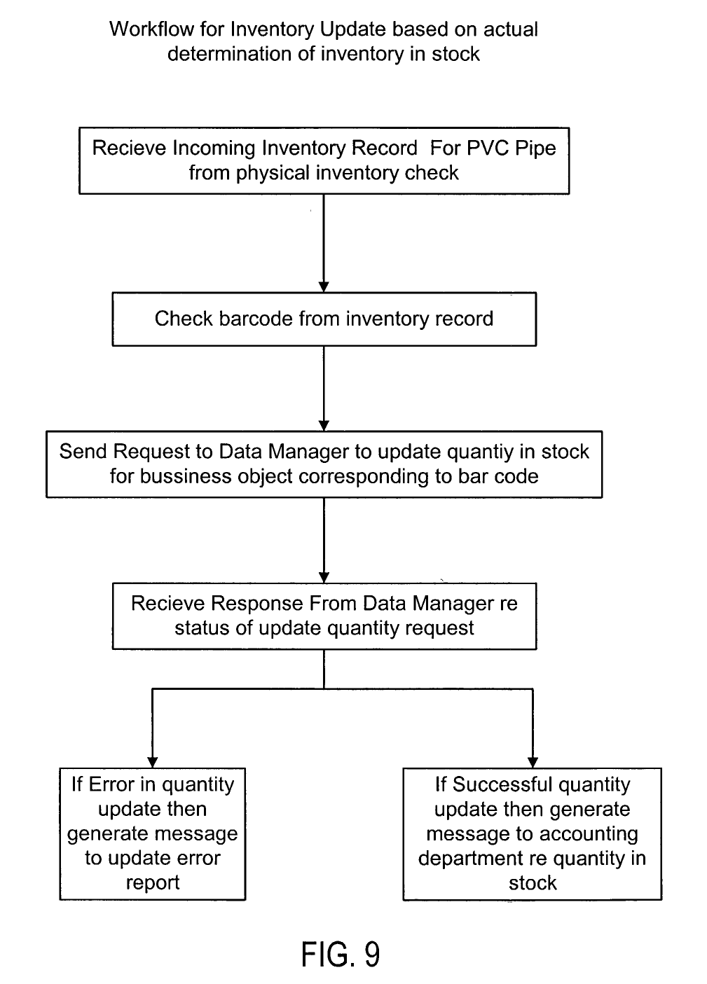

FIG. 9 is a flow chart representation of a workflow for updating an inventory record for an item based upon a physical determination of inventory, typically using HIS 560. With reference to FIG. 9, a physical inventory is taken of a store (not shown) with HIS scanner 560 and stored in memory coupled to HIS scanner 560. HIS scanner 560 is then connected to HIS adapter 562 so that the data stored in memory coupled to HIS scanner 560 can be transferred or downloaded to the system. HIS adapter 562 converts the transferred data into individual messages of the type shown in FIG. 6A, including the message shown in FIG. 6A, and transmits the individual messages onto the system bus as described above.

The following, though described only in the context of the message shown in FIG. 6A will apply to all messages of the type shown in FIG. 6A that are generated by HIS adapter 562. As described above with reference to FIG. 3, workflow engine 530, which subscribes to messages of the type INV_, will receive the message shown in FIG. 6A. Once workflow engine 530 determines that the message is of the type INV_DNLOAD, workflow engine 530 will contact DM 554 to request an instance of an FSM corresponding to the workflow for the flow chart in FIG. 9. As described above, DM 554 sends a response back to workflow engine 530 with information necessary for workflow engine 530 to create an instance of the appropriate FSM. Workflow engine 530 will then execute the steps shown in FIG. 9. Workflow engine 530 will check the barcode in the message shown in FIG. 6A. Workflow engine 530 will then send a message (not shown) to DM 554 to update the quantity for a business object corresponding to barcode=23614 so that the quantity in stock is set equal to 14. DM 554 will perform a look up of the bar code and update the corresponding business object.

In one possible scenario, DM 554 then sends an INV_UPDATE_RESPONSE message, similar to that shown and described with reference to FIG. 6C, indicating that the appropriate business object was successfully updated and including an indication of the quantity now shown in stock. Workflow engine 530 will receive the INV_UPDATE_RESPONSE message and generate a message of the type EMAIL_ to apprise an accounting department of the quantity in stock. Email adapter 572 will then generate an e-mail to the accounting department including the updated quantity.

Alternatively, if the barcode lookup is unsuccessful, DM 554 will send an INV_UPDATE_REPSONSE message in which the “status” field is listed as inactive. Workflow engine 530 will receive this IINV_UPDATE_RESPONSE message and generate a message of the type EMAIL_ to a manager of the store in question. In response email adapter 572 will generate and transmit an e-mail to the store manager including an indication of the inactive barcode and quantity of items involved.

The following is an example of a Auto Reply FSM (not shown). An e-mail is received by the system at e-mail media adapter 572. E-mail media adapter 572 sends an e-mail save message (not shown) to DM 554. DM 554 responds by sending an “Email_message” to workflow engine 530. In response to the “Email_message”, workflow engine 530 selects an appropriate FSM (not shown) to execute based on a Message Tag attached to the “Email_message”. Workflow engine 530 sends a message to DM 554 requesting the appropriate FSM. DM 554 sends a response back to workflow engine 530 with information necessary for workflow engine 530 to create an instance of the appropriate FSM. Workflow engine 530 will preferably store the information from the response in a memory cache (not shown). In accordance with the appropriate FSM, workflow engine 530 will send a Populate Email message to DM 554, in order to generate an auto reply to the received e-mail. In response, DM 554 sends a response to workflow engine 530 as an out mail request (not shown). Workflow engine 530 will then send a message to out mail, which goes to an outbox associated with the e-mail adaptor 572.

In response an “Email_save” message sent from the e-mail media adaptor to the DM, the DM sends an e-mail message to the workflow engine. The workflow engine then decides which branch of the appropriate FSM mentioned above is to be executed based on the state of the message. The workflow engine determines which FSM is the appropriate FSM by examining the message tag attached to the e-mail message. Once the appropriate FSM has been determined, the workflow engine sends a request to the DM for an instance of the appropriate FSM. The DM responds by sending the workflow engine a message including the necessary information to access the appropriate FSM. The workflow engine stores the information necessary to access the appropriate FSM in a memory cache. The workflow engine then sends a Populate Email message to the DM. The DM sends a response to the workflow engine as an out mail request. The workflow engine sends a message to out mail, which preferably goes to an outbox associated with the e-mail media adaptor.

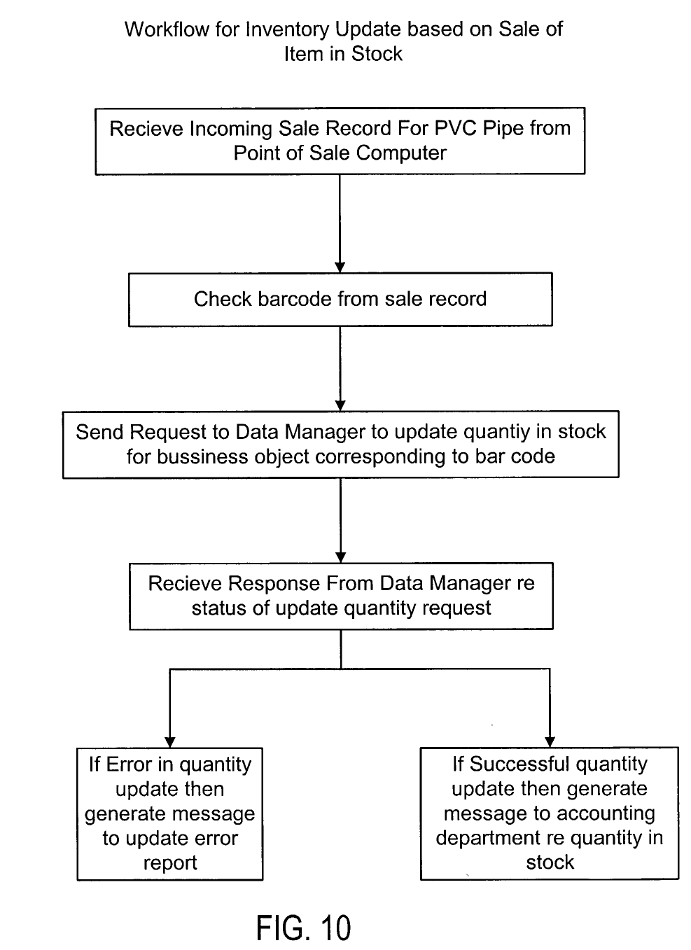

FIG. 10 is a flow chart representation of a workflow for updating inventory records based on a sale of an item at a retail location. With reference to FIG. 10, a customer (not shown) makes a purchase at the store. The purchase is processed at POS 508. POS 508 transfers the transaction information to POS adapter 510. POS adapter 510 separates the transaction data into individual barcodes and corresponding quantities. The bar code/quantity pairs are then packaged into messages of the type INV_UPDATE_ITEM, as shown in FIG. 6B, one message for each pair, for transmittal over the messaging system.

Workflow engine 530 receives a generated INV_UPDATE_ITEM message and determines witch FSM is needed to handle the message based on the message type. Workflow engine 530 then generates a message for DM 554 requesting the appropriate FSM. DM 554 responds with the information necessary for workflow engine 554 to create an instance of the FSM for the update inventory based on sale workflow depicted in FIG. 10. Workflow engine 530 will then check the barcode in the payload and send a request to DM 554 to update the quantity in stock for the business object corresponding to the barcode by decrimenting the value of the quantity. DM 554 will then attempt to update the business object corresponding to the barcode in the INV_UPDATE_ITEM message.

If the inventory update is successful, then DM 554 will generate an INV_UPDATE_RESPONSE message of the type shown in FIG. 6C for workflow engine 530. The generated INV_UPDATE_RESPONSE message indicates that the barcode is active and the quantity of the item remaining in stock. Workflow engine 530 will receive the successful INV_UPDATE_RESPONSE message and in response generate a message to email adapter 572 to update the accounting department. Email adapter 572 will then generate an email to the accounting department advising them of the sale and the quantity remaining in stock. Alternatively, if the inventory update is not successful, then DM 554 will generate an INV_UPDATE_RESPONSE message indicating that the barcode is inactive. In response to the INV_UPDATE_RESPONSE message indicating failure, workflow engine 530 will generate a message to email adapter 572 to e-mail the store manager to advise the manager that a sale included an item that is not in the database. Email adapter 572 will then generate an email to the manager advising of the error.

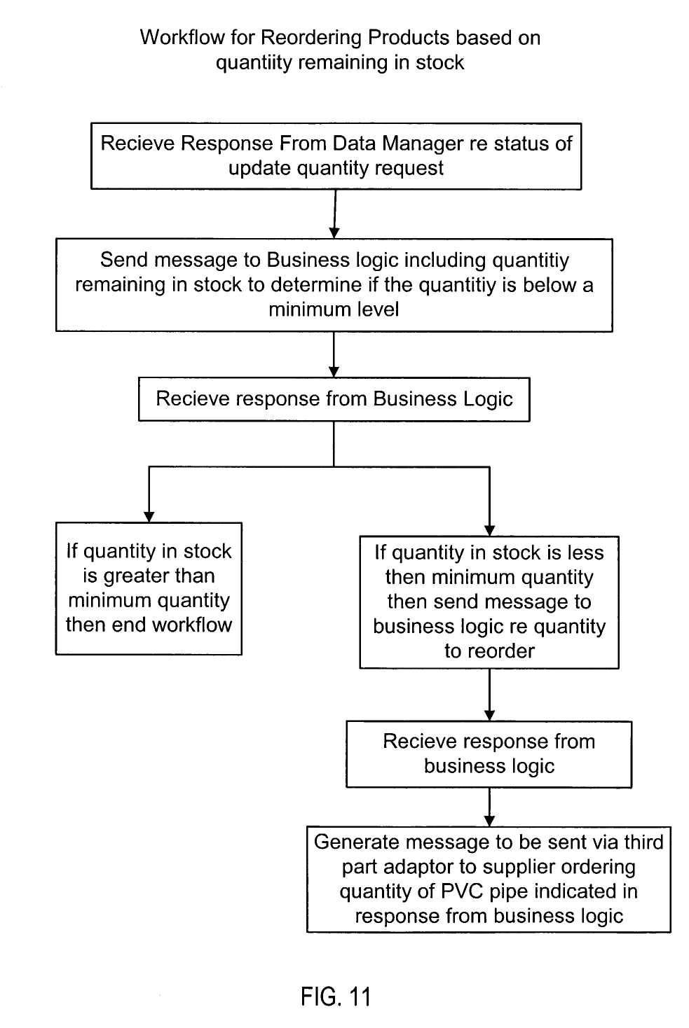

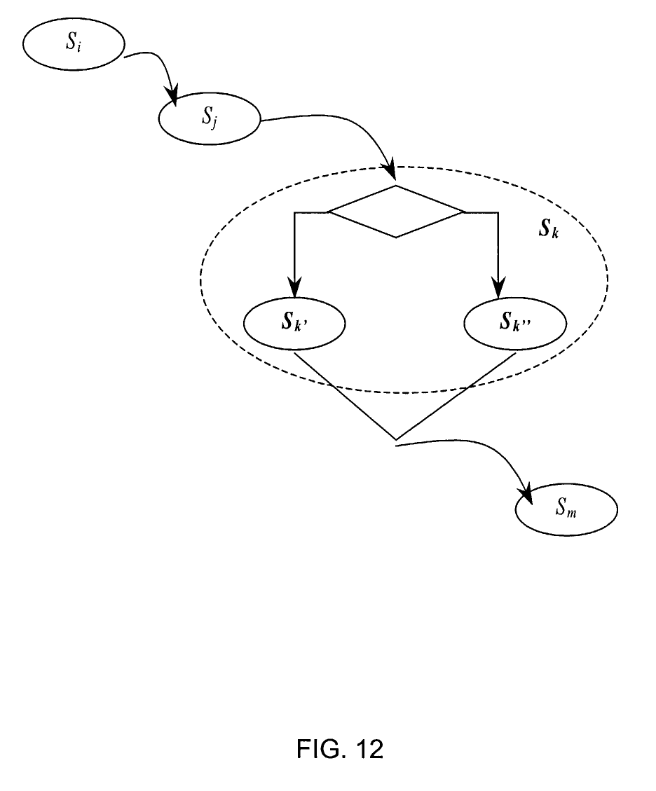

FIG. 11 is a flow chart representation of a workflow for re-ordering an item based on the quantity of the item remaining in a store's inventory. In the workflows shown in both FIG. 9 and 10 a successful inventory update leads to DM 554 generating a INV_UPDATE_REPONSE message including a field for quantity in stock. When workflow 530 receives this message it determines a workflow to be started based on the type of the message, INV_UPDATE_RESPONSE, and the inclusion of the value for quantity in stock. The workflow, shown in FIG. 11, is designed to determine if the store needs to order more inventory for the item in question. Workflow engine 530 receives the message and generates a message to DM 554 requesting the corresponding FSM. DM 554 responds with a message including the information necessary for workflow engine 530 to create an instance of the appropriate FSM. Workflow engine 530 then creates an instance of the appropriate FSM.

Workflow engine 530 then begins to execute the appropriate FSM by sending a message to business logic 22 (shown in FIG. 1) including the quantity remaining in stock. In response, Business Logic 22 checks with the appropriate business object to determine a minimum quantity in stock for that item. Business logic 22 then sends a response to workflow engine 530 including the quantity in stock and the required minimum quantity. Workflow engine 530 then compares the quantity in stock to the required minimum quantity. If the quantity in stock is greater than the minimum quantity then the current workflow is completed. If however, the quantity in stock is less than or equal to the minimum quantity, then workflow engine 530 generate a message to third party adapter 540 for PVC, Inc. to reorder the item. Third part interface 542 translates the message and places a reorder with PVC, Inc.

A workflow in accordance with the present invention can be represented as a Directed Acyclic Graph (DAG) with each node on the DAG representing a step in the execution of the workflow as shown in FIG. 12. With reference to FIG. 12, each step, such as step Si, is atomic from a users' perspective and there is always a transition from one step to another that occurs in one direction, as in the transition from Si to Sj. This state transition happens due to the introduction of an external input into the system.

A workflow in accordance with the present invention can be converted into a Finite State Machine (FSM). In an FSM representation of a workflow each step in the workflow is represented as a state in the FSM, so step Si is represented as state Si. However, this requires the maintenance of state information for all workflow threads. Maintaining threads in this manner can be unduly burdensome upon system resources under some circumstances, particularly for a system dealing with a high volume of traffic.

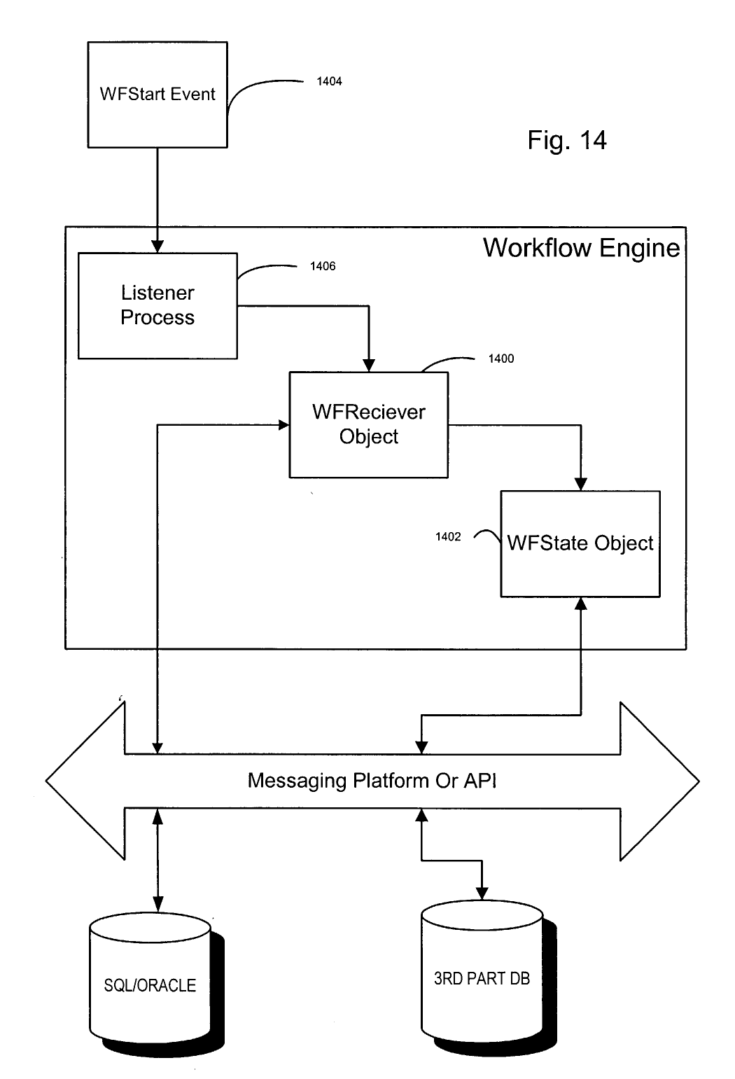

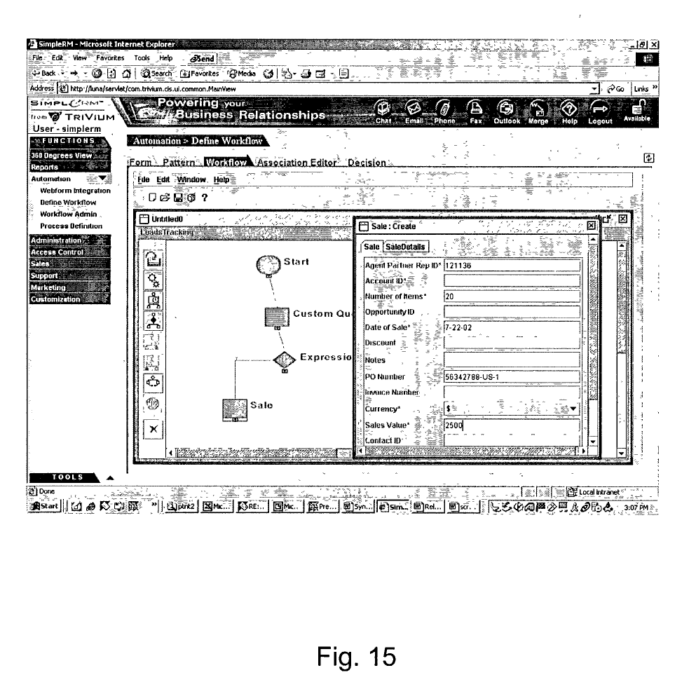

In a preferred embodiment, each state Si, as discussed above with regard to FIG. 12, is represented as two objects. The first object is WFReceiver object 1400 (shown in FIG. 14) and has the characteristics as shown in Table 3. The second object is a WFState object 1402 and has characteristics as shown in Table 4. WFRReceiver object 1400 defines a first state of an FSM at an invocation of a first step. WFReciever object 1400 also includes a second state the FSM should transition to, after completing the first step. An input for a particular step of the FSM, commonly just an output of a previous step, and any new external inputs that are expected at the particular step of the FSM are a well defined type as is an output of the particular step of the FSM.

TABLE 3

| Field | Type |
|---|---|
| CurrentState | StateID String |
| NextState | StateID string |
| ExpectedInputs | Name-Value Pairs |
| CreatedOutputs | Name-Value Pairs |

TABLE 4

| Field | State |
|---|---|
| Gateway | ConnectorID String |
| Adapter | AdapterID String |
| Operation | ObjectMethod String |
| CurrentState | StateID String |
| NextState | StateID String |
| OperationInputs | Name-Value Pairs |

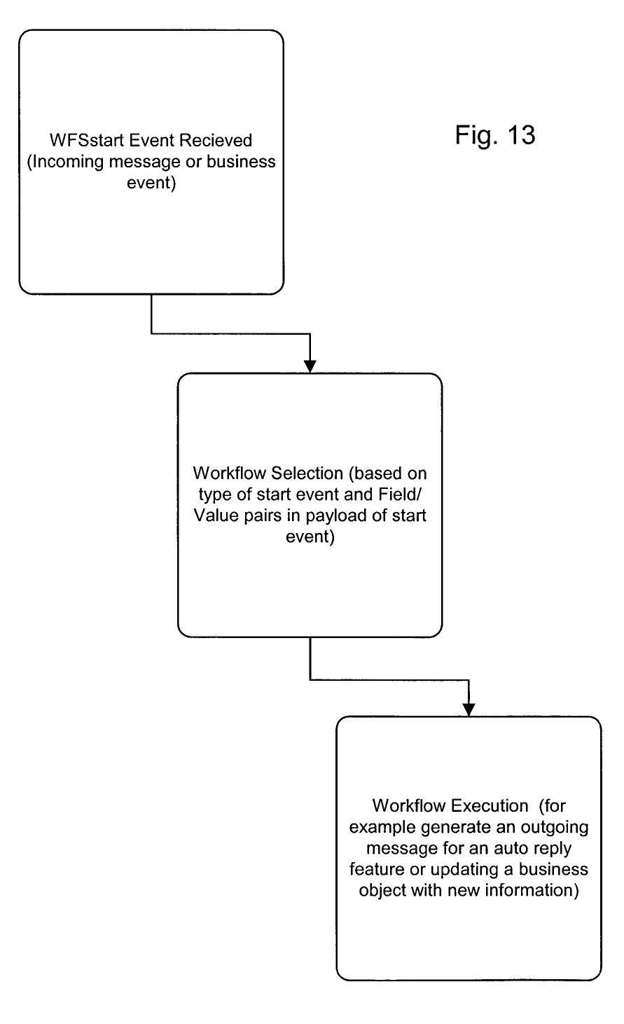

The input to any step of the workflow is preferably the output of the previous step, along with any new external inputs that are expected at this stage in the FSM. Such external inputs appear on the message platform as events of type WFStart, as shown in FIG. 13.

FIG. 14 shows a block diagram of the inner workings of workflow engine 530 that is typically triggered when workflow engine 530 receives a WFStart event 1404 as shown in FIG. 13. With reference to FIG. 14, a “listener” process 1406 reads the message, extracts the header and uses the name-value pairs of the payload (as shown in FIG. 5 A) to create a WFReceiver object 1400.

Once WFReciever object 1400 is created, it invokes WFState object 1402. WFState object 1402 defines any external object manipulations/executions that are to be undertaken on the inputs at this state of the FSM, and generates the outputs defined in WFReciever object 1400. WFState object 1402 is used to perform an operation on the gateway/adapter as defined above. A byproduct of the creation of these two objects is that the workflow's context is continually updated and stored in a memory cache.

For example, in the present invention, WFState 1402 object may need to create a customer object (not shown). To do this, WFState object 1402 must send a message to DM 554 using messaging platform 504. The message contains the fields shown in, and described with reference to, FIGS. 5A, B and C as well as those shown in Table 5. Once the message is sent, the FSM is swapped out of memory and is effectively terminated, thus relinquishing all CPU and memory resources it may have been consuming.

TABLE 5

| Field | State |
|---|---|
| Header | |
| FSM-Id | FSMName String |
| TrackingID | FSMInstance String |
| NextState | StateID String |
| ContextInformation | Name-Value Pairs |
| Payload | |

On receiving the message, DM 554 executes the query and creates a customer object. A response message is then sent from DM 554 to workflow engine 530. The response message uses the header information of the previous message (shown above) in it. Workflow engine 530 uses the header of response message to spawn the instance of the same FSM and the system is brought to the next step of the workflow. The context information from the memory cache is used to set the in-memory system, user and environment data.

In other words, the present invention can include state information with each message that is initiated by a workflow, and thus obviate the need for maintaining each workflow thread. This allows the system to avoid the overhead that can be caused by maintaining a large number of threads at one time. Data and synchronization of state between objects is combined into each message sent by the workflow.

In a preferred embodiment of the invention each message generated by workflow engine 530, or responding to a message from workflow engine 530, includes information in its header identifying the FSM that generated the message and the state of the FSM when the message was generated. Preferably each FSM has a corresponding hash table stored in database 552. The corresponding hash table is table with a unique value for each possible state of the FSM. A unique value for each state of the FSM can be obtained by operating on the FSM with a custom hash function that was designed with the particular FSM in mind so that the results include a unique value for each possible state.

In this way workflow engine 530 can quickly recover state for an FSM whenever it receives a message relating to that FSM by sending a request to DM 554 with the current state of a particular workflow, taken from the header of an appropriate message, and quickly receive a response from DM 554 indicating the next step, or state, required for that particular workflow. This lessens the strain on a high volume system in accordance with the invention because it obviates the need for maintaining a thread for each workflow that is still in process. Both data and state are included in each message sent over the system allowing workflow engine 530 to quickly move to the next step in any given workflow without requiring the resources necessary to actually maintain all active workflows.

In a preferred embodiment a workflow can be created in a workflow editor 1500 as shown in FIG. 15. With reference to FIG. 15, the workflow editor is preferably a graphical user interface (GUI) environment using drag and drop features to create a flowchart representation 1502 of a set of steps that comprises the workflow. In creating the workflow, a user can easily use an output from a first step in the process as an input for a second step of the process using drag and drop features. The GUI allows the user to easily define associations between steps in the workflow. Once the flowchart representation of the workflow has been created it is sent to a workflow compiler (not shown) that compiles and stores an FSM representation of the workflow. In a preferred embodiment the user will click on a “submit button” to initiate the compiling and saving. The workflow editor will then send an “FSM_Save” message over the system bus to DM 554. DM 554 will then save the FSM in database 552 and generates a DB-RESPONSE message to acknowledge that the FSM was successfully saved.

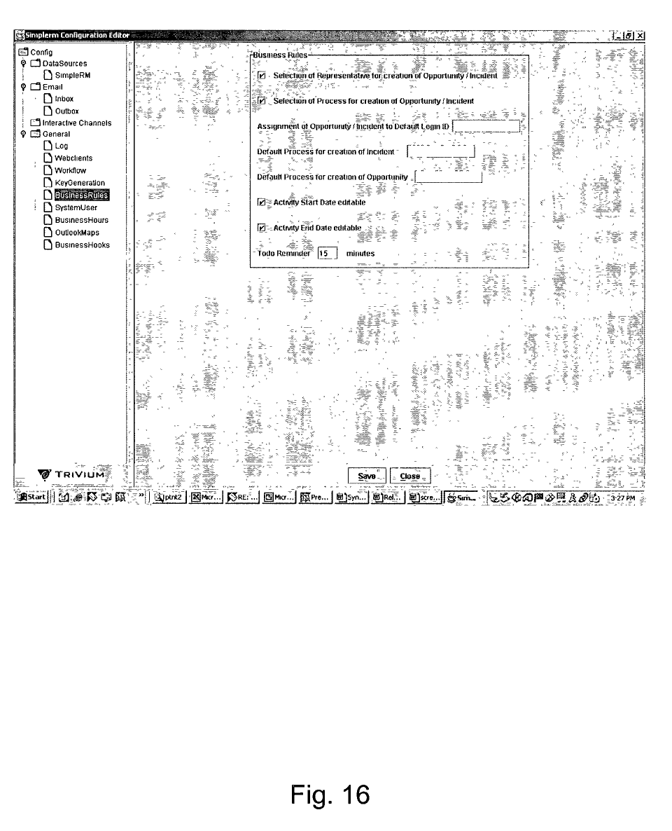

Furthermore, business rules and workflows can be controlled at an organizational level through a GUI interface for administrative control, as shown in FIG. 16. With reference to FIG. 16, an administrator (not shown) can define which workflows will be used in response to a particular type of input event or incoming message. For example, the administrator can define an auto reply workflow, as discussed above, to respond to web form submissions, or a workflow as discussed above with reference to FIG. 9 in response to a download from HIS 560. This allows for uniform response across an organization.

It will be obvious to those having skill in the art that many changes may be made to the details of the above-described embodiments of this invention without departing from the underlying principles thereof. The scope of the present invention should, therefore, be determined only by the following claims.

1. A system for executing a workflow comprising:
a workflow engine operable to receive an input message having a characteristic and data, the workflow engine operable to implement a predetermined finite state machine, based on the characteristic of the input message;
the workflow engine operable to transmit a first message including a first header and a first data set to a first object based on a first requirement of the predetermined finite state machine, and receive a second message from the first object, the first object having a first function, and operable to receive the first message from the workflow engine, execute the first function based on the first data set, generate a second message including a second header and second data set representing a result of the executed first function, and transmit the second message to the workflow engine;
a message platform operable to transfer first and second messages between the first object and the workflow engine.

2. A system for executing a workflow according to claim 1 wherein, the workflow engine is operable to transmit a third message including a third header and third data set to a second object based on a second requirement of the predetermined finite state machine, the identity of the second object determined based on the second data set, the second object having a second function, and operable to receive the third message from the workflow engine, execute the second function based on the third data set, generate a fourth message including a fourth header and a fourth data set, and transmit the fourth message to the workflow engine.

3. A system for executing a workflow according to claim 2 wherein the workflow engine reimplements the predetermined finite state machine upon receipt of the second message.

4. A system for executing a workflow according to claim 3 wherein the workflow engine determines a current state for the predetermined finite state machine based on the second header and the second data set.

5. A system for executing a workflow according to claim 2 wherein the workflow engine reimplements the predetermined finite state machine upon receipt of the fourth message.

6. A system for executing a workflow according to claim 5 wherein the workflow engine determines a current state for the predetermined finite state machine based on the fourth header and the fourth data set.

7. A system for executing a workflow according to claim 1 wherein each possible state of the predetermined finite state machine is stored in a table and the workflow engine determines an appropriate state of the predetermined finite state machine based on the second header and the second data set.

8. A system for executing a workflow according to claim 2 wherein in each possible state of the predetermined finite state machine is stored in a table and the workflow engine determines an appropriate state of the predetermined finite state machine based on the fourth header and the fourth data set by comparing state information in the fourth header with possible states stored in the table.

9. A system for executing a workflow according to claim 8 wherein the table includes a unique value for each possible state of the predetermined finite state machine generated by operating on the finite state machine with an appropriate hash function.

10. A method of executing a workflow in a business computer platform comprising:
providing a workflow engine operable to send and receive messages;
providing a first object having a first function and operable to send and receive messages;
in the workflow engine, receiving a first message including a first header and a first data set, and creating an instance of a first workflow based on the first header;
the first workflow including a predetermined set of workflow rules, each workflow rule prescribing a respective task to be executed based on a current state of the workflow;
in the workflow engine, determining a first workflow rule of the predetermined set of workflow rules to be followed based on the first header, generating a second message including a first state of the first workflow and a portion of the first data based on the first workflow rule, and sending the second message;
in the first object, receiving the second message from the workflow engine, executing the first function on the portion of the first data, generating a third message including the first state of the first workflow and a second data set based in part on the execution of the first function on the portion of the first data; and
in the workflow engine, receiving the third message from the first object and determining a second state of the workflow based on the first state of the workflow and the second data set, and determining a second rule in the set of workflow rules to follow, based on the second state of the workflow.

11. A method of executing a workflow according to claim 10 further comprising:
in the workflow engine, generating a fourth message including the second state of the first workflow and a portion of the second data set based on the second workflow rule, and sending the fourth message;
providing a second object having a second function and operable to send and receive messages; and
in the second object, receiving the fourth message from the workflow engine, executing the second function on the portion of the first data, generating a fifth message including the second state of the first workflow and a third data set based in part on the execution of the second function on the portion of the second data set.

12. A method of executing a workflow according to claim 10 further comprising:
in the workflow engine, terminating the instance of the first workflow after sending the second message; and
in the workflow engine, creating a second instance of the first workflow based on the first state of the first workflow included in the third message.

13. A method of executing a workflow according to claim 11 further comprising:
in the workflow engine, terminating the second instance of the first workflow after sending the fourth message.

14. A method of executing a workflow according to claim 11 further comprising:
providing a memory device coupled to the workflow engine;
providing a hash function designed so that when operated on by the hash function, each possible state of the first workflow results in a unique value;
in the memory device, storing a table including the unique value for each possible state of the first workflow;
in the workflow engine; determining the second state of the workflow by checking the hash table to determine the first state of the workflow and the next required state of the workflow.

15. A workflow for executing a user defined set of functions in response to an incoming trigger comprising:
a first rule for performing a first predetermined function, wherein a portion of the incoming trigger is set as an input to the first function, and the first function operates on the portion of the incoming trigger and generates a first output of a first predetermined type; and
a second rule for performing a second predetermined function, wherein the first output is set as an input of the second predetermined function, and the second predetermined function operates on the first output and generates a second output of a second predetermined type.

16. A workflow for executing a user defined set of functions in response to an incoming trigger according to claim 15 wherein the first function comprises generating and sending a first message including the portion of the first trigger to a first object for performing a first action upon the portion of the first trigger and receiving a response from the first object which includes a result from the first action.

17. A workflow for executing a user defined set of functions in response to an incoming trigger according to claim 16 wherein the second function comprises generating and sending a second message including the first output to a second object for performing a second action upon the first output and receiving a response from the second object which includes a result from the second action.

18. A workflow for executing a user defined set of functions in response to an incoming trigger according to claim 17 wherein the first message includes a header identifying the workflow and the first rule.

19. A workflow for executing a user defined set of functions in response to an incoming trigger according to claim 18 wherein the second message includes a header identifying the workflow and the second rule.

20. A method of designing a workflow for use on a computer system for automating a response to an incoming trigger, the method comprising:
determining a first process having a first input for performing a first function on a first data set and generating a first output based on the function performed on the first data set;
mapping a portion of the incoming trigger to the first input and a portion of the incoming trigger to the first data set;
determining a second process having a second input for performing a second function on a second data set and generating a second output based on the function performed on the second data set; and
mapping a portion of the first output to the second input and a portion of the first output to the second data set.

21. A method of designing a workflow according to claim 20 wherein the first input is of a first predetermined type and both the first output and the second input are of a second predetermined type.

22. A method of designing a workflow according to claim 20 wherein the incoming trigger includes a set of incoming value pairs and the portion of the incoming trigger mapped to the first input is a first value pair of the set of incoming value pairs.

23. A method of designing a workflow according to claim 20 wherein the first output includes a set of output value pairs and the portion of the first output mapped to the second input is one value pair of the set of output value pairs.

24. A method of designing a workflow according to claim 20 wherein determining the first process comprises choosing a first function from a set of available functions.

25. A method of designing a workflow according to claim 20 wherein determining the second process comprises choosing a first function from a set of available functions.
